(19) United States
(12) Patent Application Publication
(10) Pub. No.: US 2019/0207656 A1
(43) Pub. Date: Jul. 4, 2019

(54) A NETWORK NODE AND A USER EQUIPMENT AND METHODS THEREON IN AN ASYMMETRIC CARRIER AGGREGATION MOBILE TELECOMMUNICATIONS SYSTEM

(71) Applicant: TELEFONAKTIEBOLAGET LM ERICSSON (PUBL), Stockholm (SE)

(72) Inventors: Mats ÅHLANDER, TÄBY (SE); Jing RAO, SOLLENTUNA (SE); George JÖNGREN, SUNDBYBERG (SE); Torbjörn WIGREN, UPPSALA (SE)

(73) Assignee: TELEFONAKTIEBOLAGET LM ERICSSON (PUBL), Stockholm (SE)

(21) Appl. No.: 16/302,521

(22) PCT Filed: May 18, 2016
(86) PCT No.: PCT/SE2016/050449

§ 371 Date: Nov. 16, 2018

(51) Int. Cl. H04B 7/0417; H04B 7/06; H04L 5/00

(52) U.S. Cl. CPC H04B 7/0417; H04B 7/0617; H04L 5/0048; H04L 5/0023; H04L 5/001

(57) ABSTRACT

The present embodiments disclose a network node (400); a method thereof; a user equipment (700) and a method thereof. The method performed by the network node (400) comprises: selecting (301) a cell-specific RS process; selecting (302) a beam scan pattern; selecting (303) 5 a UE (799); transmitting (304) a cell specific RS associated to the cell-specific RS process, to the selected UE (700); configuring (305) the UE with the selected cell-specific RS process and receiving (306) a beam report from the UE (700).

### TECHNICAL FIELD

The present disclosure relates to beamforming in general and in particular to a network node, a method therein; a user equipment and a method therein for beamforming in an asymmetric carrier aggregation based mobile communications system.

### BACKGROUND

Communication devices such as wireless device are also known as e.g. User Equipments (UE), mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless device and a network node e.g. a radio base station.

Wireless devices may further be referred to as mobile telephones, cellular telephones, laptops, or tablets with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal a network node or a server.

The cellular communications network covers a geographical area which is divided into cell areas, wherein each cell area being served by a network node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3^{rd} Generation Partnership Project (3GPP) Long Term Evolution (LTE), base stations, which may be referred to as eNodeBs or even eNBs, may be directly connected to one or more core networks.

3GPP LTE radio access standard has been developed in order to support high bitrates and low latency both for uplink and downlink traffic. All data transmission over the wireless interface is in LTE controlled by the radio base station.

In the coming evolved fourth Generation (4G) systems and in 5G, beamforming and Multiple Input Multiple Output (MIMO) transmissions will be central technologies. Increasing capacity requirements is driving this development where more and more MIMO transmission in existing frequency bands is introduced. However, this will soon become insufficient, thereby requiring migration into spectrum at higher carrier frequencies, starting at 3.5-5 GHz, continuing above to the soon available 28 GHz band and beyond, toward 60 GHz. For these higher bands, beamforming with massive antenna arrays will be needed to compensate for the worsening radio propagation. However, this development is exploited also at the lower frequency bands up to 5-6 GHz, where the 3GPP standard support for antenna arrays with increasing number of antenna elements is improving with every release.

The present disclosure is focused on exploiting beamforming opportunities that arise in the present frequency bands, and in the new lower 3.5-5 GHz bands that can be foreseen to be the ones exploited first. More precisely the disclosure combines features of the new release 13 (Rel 13) 3GPP standard that introduces enhanced support for large antenna arrays. The disclosed new technologies herein, based on such combinations, aims at solving significant problems in the existing products, and with parts of the standard itself.

To understand the problems solved by the embodiments presented in the summary part, the detailed descriptions and the drawings, some further information is needed. First it needs to be noted that two main methods are available for wireless beamforming. The first method relies on the downlink and uplink utilizing the same frequency band. Then channel reciprocity persists and a matrix channel estimated for the uplink can be used for optimal beamforming in the downlink, requiring e.g. the beamforming weights for MIMO to meet the equation WH=1, where W denoted the MIMO beamforming weight matrix, I denotes an identity matrix, and H is the channel matrix. The other method relies on reference signals being transmitted from the base station (network node). The UE then uses these known signals to measure the channel response and reports the result back to the base station in terms of CQI, RI and PMI, these quantities representing the channel quality (SNR related), channel rank, and preferred pre-coder, respectively.

A first problem addressed by the embodiments herein is associated with the channel feedback information. An important piece of that information is the Pre-coder Matrix Indicator (PMI), i.e. the feedback of the preferred pre-coder codebook. This codebook can be thought of as defining different beam directions, one direction for each entry. The codebook may represent directions in both azimuth and elevation, and it is specified in the 3GPP standard. However, it may very well be the case that a single UE is reached by radio energy that propagates from the base station along very different reflected paths, in addition to a line of sight path. In that case the matrix channel used for beamforming in the base station should reflect this spatial frequency distribution. However, in case the base station uses beamforming to reach the UE, only one of these directions would be exercised and reported back. In addition, the reporting capability of the UE is restricted to a few beam directions.

A second problem addressed herein occurs when information is to be broadcasted to all UEs (users) in a cell, in a case where beamforming is needed for data transmission in cases where coverage and not capacity is the limiting factor. It can be noted that also at lower carrier frequencies e.g. at 3.5-5 GHz it may be challenging to feed antenna elements so that a total output power comparable to that of a standard antenna site is achieved—a fact that may make coverage more interesting. Such data transmission coverage can of course be achieved with high order beamforming tuned to achieve a high antenna gain i.e. an antenna gain exceeding a predefined threshold. In such broadcast situations the transmission needs to reach all UEs in the cell and narrow beams cannot be used as is.

A third problem addressed occurs in case of an established single beam connection between a base station and a UE. At least when narrow beams are used, the beam and transmission quality could deteriorate rapidly in case an obstacle moves in between the transmitter and the receiver or in case the UE is moved around a corner. The dropped call probability is likely to increase with the inverse of the beam width, simply since the beam power varies more rapidly when the UE moves.

A fourth problem addressed herein is associated with a situation when carrier aggregation (i.e. multiple carriers) are used in the downlink and the uplink. When there is an uplink/downlink pair of carriers sharing the same frequency band reciprocity based beamforming is likely to provide the best performance since there is no codebook that limits the spatial channel resolution. So called sounding is then applied in the uplink for channel estimation, followed by beam-formed transmission in the downlink. The beamforming may focus on various types of MIMO transmission. However, the 3GPP release 13 standard allows more carriers to be aggregated in the downlink than in the uplink. Therefore, some downlink carriers cannot use reciprocity based beamforming, and feedback based channel estimation needs to be used. In such cases the single—directional codebook discussed in association with the first problem may lead to a very unbalanced situation in terms of spatial channel accuracy between downlink carriers that use reciprocity-based beamforming and those that do not. The present embodiments disclose means that mitigate this unbalance and improve capacity.

Beamforming and MIMO transmission is a mature subject today. This section just aims at presenting the basics, for a detailed treatment any textbook on digital communications could be consulted.

To explain the concept, consider FIG. 1 which shows an idealized one-dimensional beamforming case. In case it is assumed that the UE is located far away from the antenna array it follows that the difference in travel distance from the base station to the UE, between adjacent antenna elements, is:

l=kλ sin(θ)

where is the antenna element separation and k is the separation factor which may be 0.5-0.7 in a typical correlated antenna element arrangement. This means that a reference signal sᵢe^{jωt} transmitted from the i:th antenna element will arrive at the UE antenna as a weighted sum:

$${s}_{UE} = {\sum }_{i = 0}^{N - 1} {s}_{i} {h}_{i} {e}^{j ω ( t - \frac{il}{c} )} = {e}^{j ω t} {\sum }_{i = 1}^{N - 1} {s}_{i} {h}_{i} {e}^{- j \frac{ik λ si n ( θ )}{{f}_{c} λ}} = {e}^{j ω t} {\sum }_{i = 1}^{N - 1} {s}_{i} {h}_{i} {e}^{- j \frac{ik si n ( θ )}{{f}_{c}}}$$

Here ω is the angular carrier frequency, hᵢ is the complex channel from the i:th antenna element, t is the time, and f_{c} is the carrier frequency. In the above equation angle θ (shown in FIG. 1) and hᵢ are unknown. In case of a feedback solution, the UE therefore needs to search for all complex channel coefficients hᵢ and the unknown angle θ. For this reason, the 3GPP standard defines a codebook of beams in different directions given by steering vector coefficients like:

w_{m,i}=e^{-jf(m,i)}

where m indicates a directional codebook entry. The UE then tests each codebook and estimates the channel coefficients. The information rate achieved for each codebook entry m is computed and the best one defines the direction and channel coefficients. This is possible since sᵢ is known. The result is encoded and reported back to the base station. This provides the base station with a best direction (codebook entry) and information that allows it to build up a channel matrix H. This channel matrix represents the channel from each of the transmit antenna elements to each of the receive antenna elements. Typically, each element of H is represented by a complex number.

The channel matrix can then be used for beamforming computations, or the direction represented by the reported codebook entry can be used directly. In case of MIMO transmission the MIMO beamforming weight matrix W needs to be determined so that a best match to the requirement WH=I is achieved where I denotes the identity matrix as mentioned earlier. In case of an exact match each layer will become independent of other layers. This concept may be applied for single users or multiple users.

When reciprocity is used the channel coefficients may be directly estimated by the base station from UE uplink transmission. So called Sounding Reference Signals, SRSs, are used for this purpose. The estimated channel is then used to compute the combining weight matrix according to some selected principle, and then used for downlink transmission. This works since the uplink and downlink channels are the same when reciprocity is applicable.

In view of the above, a number of downlink signals need to use common, cell specific beamforming. This is true for Primary Synchronization Signal (PSS), Secondary Synchronization Signal (SSS), Cell specific Reference Signal (CRS) and Positioning Reference Signals (PRS).

The Channel State Information Reference Signal (CSI-RS) which has been introduced since 3GPP release 11, are assigned to a specific antenna port. These reference signals may be transmitted to the whole cell or may be beamformed in a UE specific manner. In 3GPP from release 13, two classes of CSI-RS reporting mode have been introduced: class A CSI-RS refers to the use of fixed-beam codebook based beamforming, while a class B CSI-RS process may send beamformed CSI-RS in any manner.

A CSI-RS process in a UE comprises detection of selected CSI-RS signals, measuring interference and noise on CSI-IM (Interference Measurement), and reporting of the related CSI information, in terms of CQI, RI and PMI. A process hence may be defined by a CSI-RS resource, a CSI-IM resource and a reporting mode. CQI denotes Channel Quality Indication, RI denotes (channel matrix) Rank Indication and PMI denotes Pre-coder Matrix Index, i.e. the selected codebook entry. A UE may report more than one set of CQI, RI and PMI, i.e. information for more than one codebook entry. Up to 4 CSI-RS processes can be set up for each UE.

The Discovery Reference Signal (DRS) was introduced in LTE 3GPP release 12. DRS may serve many purposes, for example supporting cell identification, coarse time/frequency synchronization, intra-/inter-frequency Radio Resource Management (RRM) measurement of cells and Quasi-Co-Location (QCL). The discovery signals in a DRS occasion are composed of the PSS, SSS, CRS and when configured, the channel state information reference signals (CSI-RS). In this invention, DRS comprised of CSI-RS can be utilized to assist beam searching.

As stated above the codebook of the 3GPP standard is defined to represent certain directions. In 3GPP release 13, directions in both azimuth and elevation are defined, thereby allowing 2-Dimensional (2D) beamforming to be used. The codebooks are specified in detail in 3GPP technical Report (TR) 36.897. That TR also discusses the antenna port mappings, to achieve different antenna configurations. In order to illustrate that the codebooks indeed define specific directions, it can be noted that the formula for the azimuth codebook is:

$${w}_{k} = \frac{1}{\sqrt{K}} exp ( - j \frac{2 π}{λ} ( k - 1 ) {d}_{V} cos {θ}_{etilt} ) for k = 1 , … , K$$

It has the same structure as discussed above. Similarly, the vertical codebook in that document is given by:

$${v}_{l , i} = \frac{1}{\sqrt{L}} exp ( - j \frac{2 π}{λ} ( l - 1 ) {d}_{H} sin {ϑ}_{i} ) for l = 1 , … , L$$

In the two above equations it is only the structure that is needed here, the details of the involved quantities are of less importance and are not reproduced here, see 3GPP TR 36.897 for all details.

Finally, it is noted that a 2D beam is obtained by a multiplication of the two above equations.

The allocation of antenna ports to achieve different antenna configurations are also described in 3GPP TR 36.897. The details are omitted, what is important for the present embodiments is that a specific reference signal (RS) is transmitted on a set of well defined antenna ports, a fact that allows reference signals to be separately beam-formed.

As previously disclosed release 11 and release 12 both support 4 CSI-RS processes per UE. However, only one dimensional codebooks corresponding to 8 antenna ports are supported, as compared for the support of 2D codebooks for 16 ports in release 13. However, that does not prevent the application of the techniques of this embodiments that will be described.

Carrier aggregation is a technique that makes use of multiple carriers to increase the capacity of the links to and from UEs. Typically, since the capacity demand is higher in the downlink, the number of carriers that can be aggregated is also higher in the downlink than in the uplink. When TDD is applied this means that there will be downlink carriers without a matching uplink one, therefore reciprocity based beamforming cannot be applied for this carrier. In this case, the embodiments herein may be applied instead.

The capabilities of the 3GPP standard that are relevant for the present IVD, are summarized in Table 1.

TABLE 1
Beamforming capabilities.

| | 3GPP Release 11 | 3GPP Release 12 | 3GPP Release 13 |
|---|---|---|---|
| Codebook | 1-dimensional | 1-dimensional | 2-dimensional |
| Antenna ports | 8 | 8 | 16 |
| CSI-RS | 4 | 4 | 4 |
| DSR | No | Yes | Yes |

The problems with prior art technology that is addressed by the embodiments herein include:

1. In case carrier aggregation is applied with more downlink carriers than uplink carriers, high performing reciprocity based beamforming cannot be applied for the excess downlink carriers. The feedback based schemes based on CSI-RS do not perform as well because of i) short comings in terms of PMI codebook design and ii) due to difficulties to distribute broadcast information in coverage limited scenarios.

2. More specifically, the codebook entries of LTE 3GPP releases 11, 12 and 13 represent single directions to the UE. Therefore, when a beamformed communication channel between a base station and a UE changes rapidly, due to quickly emerging obstacles or quick changes of the fading, a drop may occur. In case narrow beams are used, the beam channel quality has a potential to change more rapidly than otherwise, a fact that could lead to an even larger drop rate. Even a slight increase of the legacy drop rate is known to be unacceptable by operators.

3. Since the codebooks above represent single directions, a single codebook entry is not capable to represent signal energy from multiple directions, where the angular differences between directions are larger than the beamwidth. This means that useful energy in other directions may not be collected, which is negative for the capacity and end user experience. Note that such situations are not uncommon e.g. in cities where a LOS connection may not be available, leaving the communication to rely on multiple reflected paths.

4. In coverage limited situations, downlink data transmission needs to exploit high gain beamforming to reach UEs on the cell edge. However, when a new UE is to attach to the system, the direction to it is not known, and single directional beamforming cannot be applied. Neither is it possible to reach such UEs with general information that needs to be broadcasted to all UEs in a cell.

### SUMMARY

It is an object of embodiments herein to at least solve the above problems by providing a method and a network node (base station); a UE and a method in an asymmetric carrier aggregation mobile telecommunications system employing beamforming.

According to an aspect of embodiments herein, there is provided a method performed in a network node in an asymmetric carrier aggregation mobile telecommunications system employing beamforming, the method comprising: selecting a cell-specific reference signal process; selecting a beam scan pattern on a time-resource grid, wherein the beam scan pattern comprises a sequence of selected beams; transmitting a cell-specific reference signal, associated to the cell-specific reference signal process, according to the selected beam scan pattern comprising the sequence of selected beams; selecting at least one user equipment (UE) that is subject to the selected beam scan pattern; configuring the selected at least one UE with the selected cell-specific reference signal process; and receiving a beam report, from the at least one UE, the beam report comprising one or more of: information on at least one beam direction; and information on the channel between the network node and the UE.

According to another aspect of embodiments herein, there is provided a network node serving in an asymmetric carrier aggregation mobile telecommunications system employing beamforming, the network node comprising a processor and a memory, said memory containing instructions executable by the processor whereby the network node is operative to: select a cell-specific reference signal process; select a beam scan pattern on a time-resource grid, wherein the beam scan pattern comprises a sequence of selected beams; transmit a cell-specific reference signal, associated to the cell-specific reference signal process, according to the selected beam scan pattern comprising the sequence of selected beams; select at least one user equipment (UE) that is subject to the selected beam scan pattern; configure the selected at least one UE with the selected cell-specific reference signal process; and receive a beam report, from the at least one UE, the beam report comprising one or more of: information on at least one beam direction; and information on the channel between the network node and the UE.

According to another aspect of embodiments herein, there is provided a method performed by a user equipment (UE) in an asymmetric carrier aggregation mobile telecommunications system employing beamforming, the method comprising: receiving, from a network node a cell-specific reference signal associated to a cell-specific reference signal process, according to a beam scan pattern comprising the sequence of selected beams, selected by the network node; receiving a configuration from the network node, the configuration configuring the UE with the selected cell-specific reference signal process; and transmitting a beam report, to the network node, the beam report comprising one or more of: information on at least one beam direction; and information on the channel between the network node and the UE.

The reception of the configuration may be performed together or upon receiving the cell-specific RS signal associated with the cell-specific RS process.

According to another aspect of embodiments herein, there is provided a user equipment (UE) in an asymmetric carrier aggregation mobile telecommunications system employing beamforming, the UE comprising a processor and a memory, said memory containing instructions executable by the processor whereby the UE is operative to: receive, from a network node a cell-specific reference signal associated with a cell-specific reference signal process, according to a beam scan pattern comprising the sequence of selected beams, selected by the network node; receive a configuration from the network node, the configuration configuring the UE with the selected cell-specific reference signal process; and transmit a beam report, to the network node, the beam report comprising one or more of: information on at least one beam direction; and information on the channel between the network node and the UE.

Advantages of the embodiments herein include:

Improved and more uniform performance in case of asymmetric carrier aggregation involving reciprocity based beamforming and MIMO, by: Improved Key Performance Indicators (KPIs) by the use of multiple high gain feedback based beam forming; Optimal use of more spatial dimensions, when feedback type beamforming is applied; Resource efficient background beam scan, by the use of cell specific CSI-RS for the scan, allowing all UEs to share the scan resource.

### BRIEF DESCRIPTION OF THE DRAWINGS

Examples of embodiments herein are described in more detail with reference to attached drawings in which:

FIG. 1 is a scenario illustrating a UE and an antenna array used for beamforming.

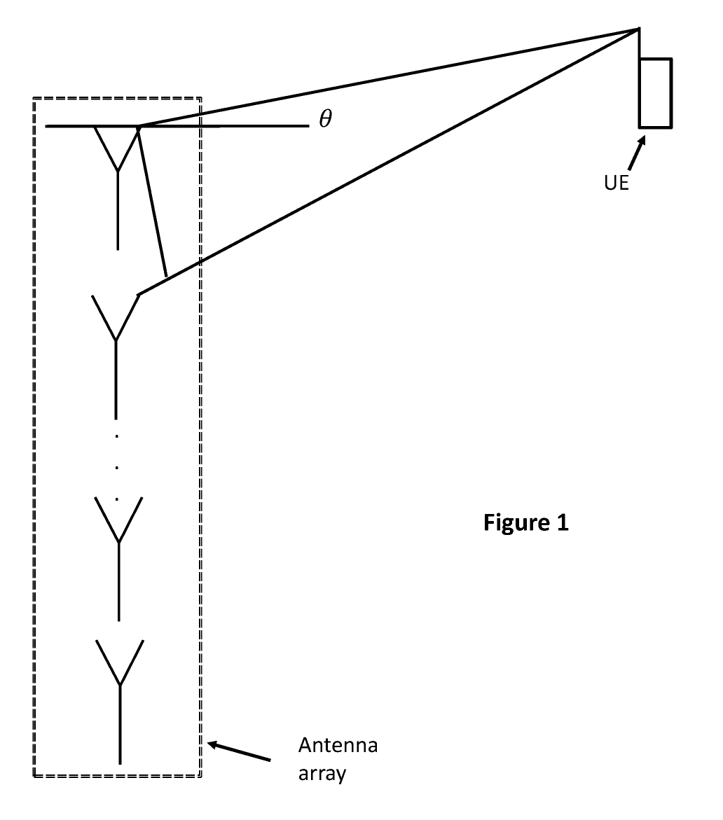

FIG. 2 depicts a schematic view of a network node (base station) with 3GPP release antenna functionality using a background scan process according to an embodiment herein.

FIG. 3 illustrates a flowchart of a method performed by a network node according to embodiments herein.

FIG. 4 illustrates a block diagram of a network node according to embodiments herein.

FIG. 5 depicts a schematic view of a network node (base station) with 3GPP release antenna functionality using a background scan process with fine scan beams according to an embodiment herein.

FIG. 6 shows a flowchart of a method performed by a UE according to embodiments herein.

FIG. 7 shows a block diagram of a UE according to embodiments herein.

### DETAILED DESCRIPTION

In the following, a detailed description of the exemplary embodiments is described in conjunction with the drawings, in several scenarios to enable easier understanding the embodiments herein.

The present embodiments combine different features of LTE Rel 11, 12 and 13, in new ways to solve the above problems, primarily for asymmetric downlink and uplink carrier aggregation, where reciprocity based beamforming and MIMO processing cannot be used for the downlink excess carriers.

To achieve this goal, the exemplary embodiments disclose the use of up to a number of parallel reference signal processes e.g. 4 parallel CSI-RS processes for each UE:

Below is presented an example using the CSI-RS process as a reference signal process and showing how to achieve the above mentioned goal. Note that other reference signals may be used e.g. a Discovery Reference signal (DRS).

For each UE, the following may be performed:
To perform background beam search on one beamformed cell specific CSI-RS process of each UE, thereby allowing all configured UEs in a cell to detect new beams based on this cell-specific beamformed CSI-process.
For each UE assign a UE specific CSI-process, for each of the found beams of said UE. The number of processes and the number of beams may take any suitable value e.g. 3 or 4 etc.
For each UE perform UE specific downlink beamformed transmission based on the assigned UE specific CSI-RS processes.
In case the number of antenna elements exceeds the number of antenna ports and thereby the codebook resolution, to perform further refined UE specific beam search by spatial oversampling of the beam of each assigned CSI-RS process.
To apply the above steps for downlink excess carriers that cannot use reciprocity based beamforming.

It can be noted that the above procedure is applicable to 3GPP LTE releases 11, 12 and 13. The procedure results in UEs that automatically find up to 3 UE specific beam directions in release 11. In release 12 and 13 the discovery signal (DRS) may replace the cell specific CS-/RS process used for beam search, in which case up to 4 beam directions for each UE may be found. Furthermore, with a CSI-RS process assigned for each beam, the UE is able to detect energy from multiple directions, thereby potentially increasing channel capacity and reducing the risk of dropped connections. In addition, the procedure may be applicable to provide longer range for information that needs to be broadcasted. The present disclosure applies this in order to enhance the performance of excess carriers that cannot rely on reciprocity based transmission schemes i.e. in an unbalanced scenario where the number of DL carriers exceeds the number of UL carriers.

Hence, the embodiments herein are intended for asymmetric carrier aggregation scenarios. The first step is therefore that the radio network node or eNB determines that this is the case, after which the procedure is applied. It is therefore considered here the the radio network node already determined this scenario.

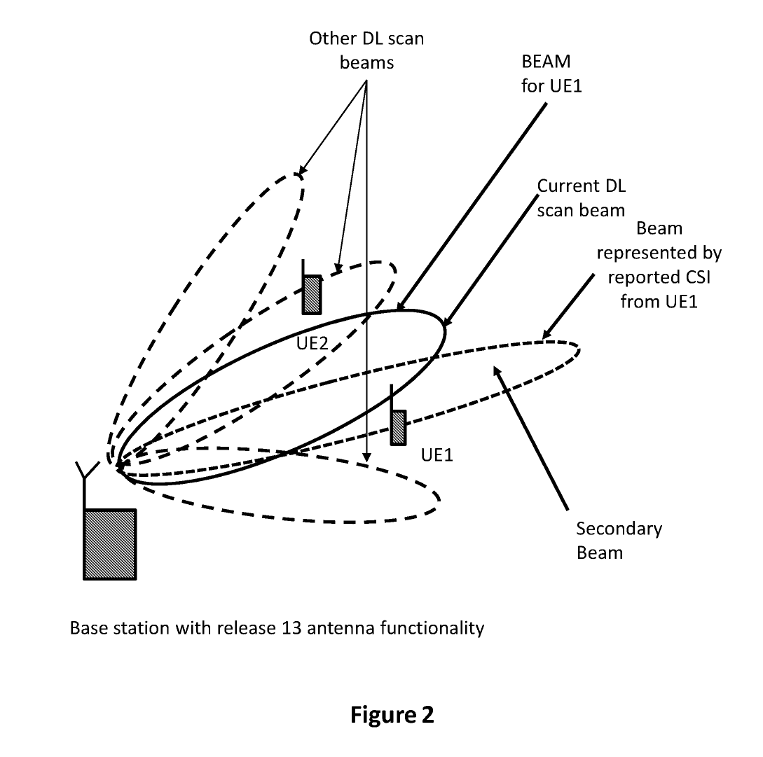

The background beam search according to an embodiment herein may be understood from FIG. 2. That figure depicts an example of an ongoing communication process between the radio network node or base station and UE 1. A second UE, UE 2 is also depicted. As shown it is here assumed that the base station has a 3GPP Release 13 antenna functionality.

In this case one DL beam (denoted “Beam for UE 1) is used, that utilize a Line Of Sight (LOS) propagation path. The other DL scan beams emitted by the base station are also shown. A UE-specific CSI-RS process is used to support the transmission. The exact beam former applied may be based on the exact codebook directions fed back when the beam was first searched for. Note that in case a wider beam was used for this search, the feedback would have provided a more precise beam direction, via PMI feedback.

It should be mentioned that UE 1 may also be reached with a reflected path. That direction has not yet been detected in the UE. However, the proposed beam scan function is operating in the background by a second cell specific CSI-RS process or a DRS common for all UEs in the cell. The choice depends on the release supported by the UE. UE 1 is configured to measure the signal on the cell-specific CSI-RS process and reports back a channel state information e.g. a quality of the channel e.g. CQI (if it's a CSI-RS process) or Receive Signal Received Power (RSRP) (if it's DRS) at configured occasions, while the base station transmits the CSI-RS signal at the same configured occasions. In this way the UE may finally detect signal energy in the new direction, and a secondary beam (denoted Secondary Beam in FIG. 2) may be added, by assigning another UE specific CSI-RS process. The secondary beam is also denoted “Beam represented by reported channel state information (CSI) from UE 1”.

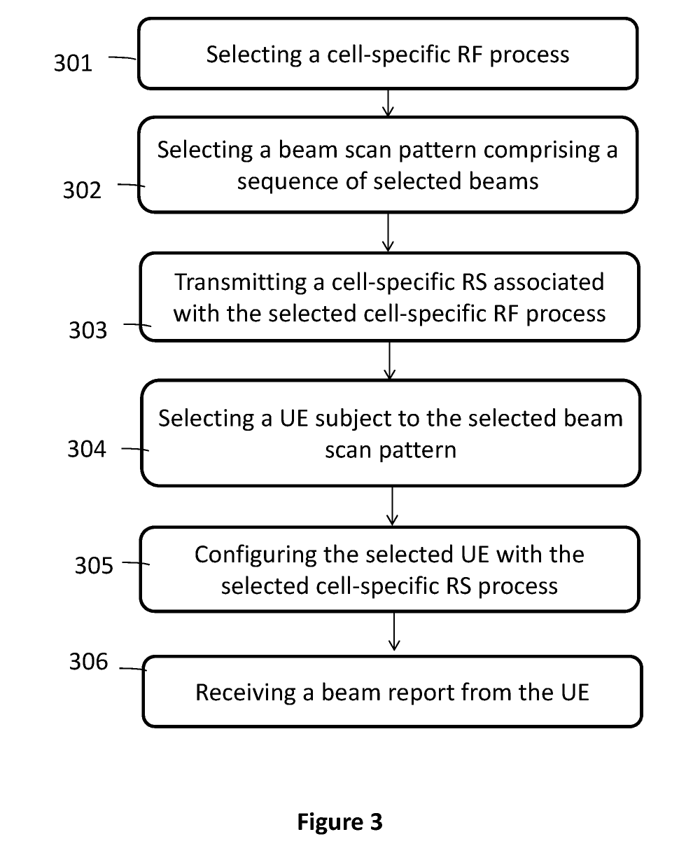

Before going into additional details on the embodiments herein, the main method steps or actions performed by the network node will now be presented in concordance with FIG. 3. The method comprising:

(301) selecting a cell-specific reference signal process; which may be a CSI-RS process or a DRS;

(302) selecting a beam scan pattern on a time-resource grid, wherein the beam scan pattern comprises a sequence of selected beams;

(303) transmitting a cell-specific reference signal, associated to a cell, associated to the cell-specific reference signal process, according to the selected beam scan pattern comprising the sequence of selected beams;

(304) selecting at least one UE that is subject to the selected beam scan pattern;

(305) configuring the selected UE with the selected cell-specific reference signal process; and

(306) receiving a beam report from the UE, the beam report comprising one or more information of: information on at least one beam direction; and information on the channel between the network node and the UE.

It should be mentioned that a CSI-RS process may be viewed as comprising or including a CSI RS configuration which defines the resource elements on which a UE should measure the CSI RS power. The CSI process may also include, as previously mentioned, a CSI-IM configuration on which the UE measures the corresponding interference level.

The method also comprises assigning the cell-specific reference signal process to the UE for each beam of the UE.

The method also comprises adding beam directions with an energy higher than a predefined threshold to ongoing beamformed transmissions.

The method also comprising, computing or calculating beamforming weights for all UEs in the cell served by the network node and transmitting the beams according to those weights.

The method further comprises receiving the beam report at configured occasions while the network node transmits the cell-specific reference signal at the same configured occasions.

The method also comprises adding a new beam by assigning a new UE specific cell-specific reference signal process.

The method also comprises updating a channel matrix with the cell-specific reference signal process and configuring beam scan for additional UEs and/or removing existing configurations of beam scan from UEs currently subject to the beam scan process.

The method also comprises increasing or reducing the width of the beam and and associated antenna gain offered by a codebook entry of the antenna defining a direction of the beam and forming four beams with directions on each side of the direction defined by the codebook entry and scheduling subsequent beamformed transmission in these directions.

The method further comprises receiving channel state information from each of the four directions and selecting the direction having a channel quality information (CQI) having the highest CQI among the received channel state information received from the four directions.

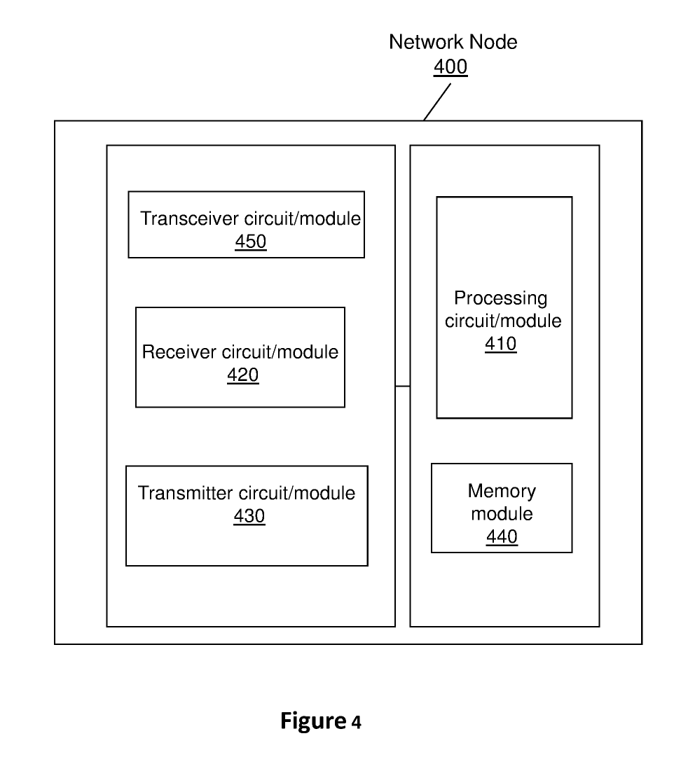

Referring to FIG. 4, there is illustrated a block diagram of a network node 400 configured to operate in an asymmetric carrier aggregation based mobile telecommunications system employing beamforming, according to embodiments herein. The network node (e.g. a radio base station, an access point, a NodeB, an eNodeB, etc.) 400 comprises a processing circuit or a processing module or a processor or means 410, antenna circuitry (not shown); a receiver circuit or receiver module 420; a transmitter circuit or transmitter circuit 430; a memory module 440 and a transceiver circuit or transceiver module 450 which may include the transmitter circuit 430 and the receiver circuit 420.

The processing module/circuit 410 includes a processor, microprocessor, an application specific integrated circuit (ASIC), field programmable gate array (FPGA), or the like, and may be referred to as the “processor 410.” The processor 410 controls the operation of the network node 400 and its components. Memory (circuit or module) 440 includes a random access memory (RAM), a read only memory (ROM), and/or another type of memory to store data and instructions that may be used by processor 410. In general, it will be understood that the network node 400 in one or more embodiments includes fixed or programmed circuitry that is configured to carry out the operations in any of the embodiments disclosed herein.

In at least one such example, the network node 400 includes a microprocessor, microcontroller, DSP, ASIC, FPGA, or other processing circuitry that is configured to execute computer program instructions from a computer program stored in a non-transitory computer-readable medium that is in, or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the network node operations disclosed herein. Further, it will be appreciated that the network node 400 may comprise additional components not shown in FIG. 4.

The processing circuit 410 is configured to select a cell-specific reference signal process; select a beam scan pattern on a time-resource grid, wherein the beam scan pattern comprises a sequence of selected beams; transmit the cell-specific reference signal, associated to the cell-specific reference signal process, according to the selected beam scan pattern comprising the sequence of selected beams; select at least one user equipment, UE, that is subject to the selected beam scan pattern; configure the selected at least one UE with the selected cell-specific reference signal; and receive a beam report, from the at least one UE, the beam report comprising one or more of: information on at least one beam direction; and information on the channel between the network node and the UE.

The processing circuit or module 410 is further configured to assign the cell-specific reference signal process to the UE, for each beam of said UE. The processing circuit 410 is further configured to add beam directions with an energy higher than a predefined threshold to ongoing beamformed transmissions.

The processing circuit 410 is further configured to compute beamforming transmission weights for all UEs in a cell served by the network node and transmitting according to said the computed weights and to receive the beam report is done at configured occasions while the network node 400 transmits the cell-specific reference signal at the same configured occasions. The processing circuit 410 is further configured to add a new beam by assigning a new UE specific cell-specific reference signal process and to update a channel matrix using a channel state information feedback received from the UE configured with the cell-specific reference signal process. The processing circuit 410 is further configured to beam scan for additional UEs and/or remove existing configurations of beam scan from UEs currently subject to the beam scan pattern. The processing circuit 410 is further configured to increase or reduce a width of the beam and an associated antenna gain offered by a codebook entry of the antenna defining a direction of the beam. The processing circuit 410 is further configured to form four beams with directions on each side of the direction defined by the codebook entry and scheduling subsequent beamformed transmissions in these directions. The processing circuit 410 is further configured to receive channel state information from each of the four directions and select the direction having a channel quality information, CQI, having highest CQI among the received channel state information received from the four directions.

Hence according to embodiments herein, the network node (e.g. a radio base station) is configured to select a cell specific CSI-RS process or a DRS and performs setup of a beam scan pattern, on the time-resource grid used in LTE (and similarly in 5G). The beam scan pattern may be selected to be a sequence of beams selected from the code book of the standard. In case more releases are to be supported, either more than one cell specific CSI-RS process (or DRS) may be used, or a common subset of the codebooks of multiple releases may be used. The UE(s) that is/are subject to beam scan are selected, according to selected priorities, the service, or another criterion. Note that all UEs may not be subject to beam scan. The selected UE(s) is/are configured with the cell specific CSI-RS process or DRS, as described above. The selected UE(s) is/are configured to do reporting based on non-QCL (non quasi co-located). The selected reporting options are also configured. This may comprise a reporting of more than one beam direction per reporting instance. The following steps may then be repeated:
The network node 400 is configured to transmit the cell specific CSI-RS according to the selected scan pattern.
The UE(s) is/are configured with the appropriate cell specific CSI-process, perform(s) CSI-RS detection, reporting CSI information or RSRP back to the network node 400 in line with the 3GPP release 11, 12 or 13 standard.
The CSI feedback information is received in the network node 400, for each UE configured with the cell-specific CSI-RS process in question.
The network node 400 is configured to use or employ the received feedback information to update the channel matrix for each UE configured with the cell-specific CSI-RS process.
The network node 400 may further be configured to determine to add beam directions with sufficiently high energy to ongoing beamformed transmissions.
The network node 400 may be configured to compute new beam forming/IMO transmission weights for all UEs, and to continue transmission according to said weights.
The network node 400 may be configured to beam scan for additional UEs, and/or to remove existing configurations of beam scan, from UEs currently being subject to a beam scan.

According to an embodiment a refined beam search may be performed. For example, in case the number of antenna elements are larger than the number of antenna ports, the beamwidth and antenna gain offered by the codebook may be reduced and increased, respectively by the network node 400. This requires using the available antenna elements to do beamforming in a more advantageous direction than offered by the selected codebook entry.

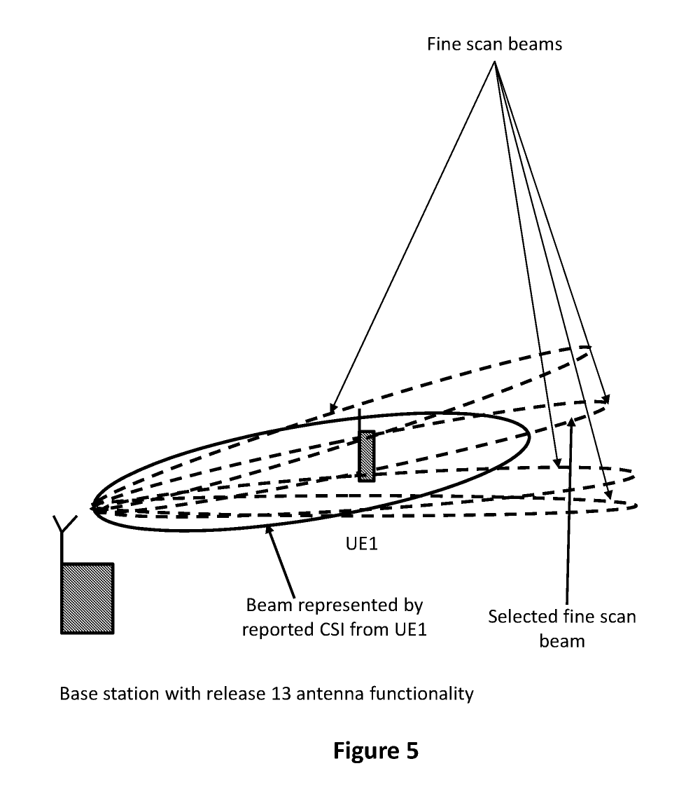

In order to find such a direction a spatial oversampling procedure is here suggested here. The oversampling is illustrated by FIG. 5. In that figure it is assumed, as an example, that there are 4 times more antenna elements than antenna ports. Spatial oversampling then allows 4 beams to be formed with directions on each side of the direction defined by the codebook entry. The 4 beams are named “Fine scan beams” in FIG. 5. The network node (named base station in FIG. 5) is configured to schedule subsequent beamformed transmissions in these 4 oversampled directions, and collects CSI-information from at least one UE. Only one UE is shown in FIG. 5. This search uses each of the UE specific CSI-RS processes that have been obtained from the beam search above. The PMI is discarded in each case, while the best CQI is used as an indication of a best oversampled direction. This direction is selected for beamforming ahead in time. The beam represented by the CSI reported by the depicted UE1 is also shown and further the selected fine beam scan is also shown schematically covering UE1.

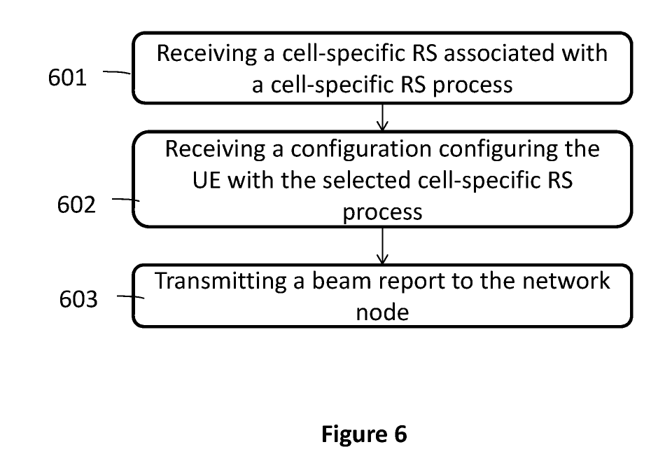

Referring to FIG. 6 there is illustrated the main method steps or method actions performed by the UE according to embodiments herein. The method comprising:

(601) receiving from a network node, a cell-specific reference signal (RS) associated with a cell-specific RS process profess;

(602) receiving, from the network node, a configuration configuring the UE with the cell-specific RS process which is selected by the network node according to a beam scan pattern comprising the sequence of selected beams;

(603) transmitting a beam report to the network node; the beam report comprising one or more of: information on at least one beam direction; and information on the channel between the network node and the UE.

The configuration configuring the UE may be received as part of the reception of the RS and together with the RS.

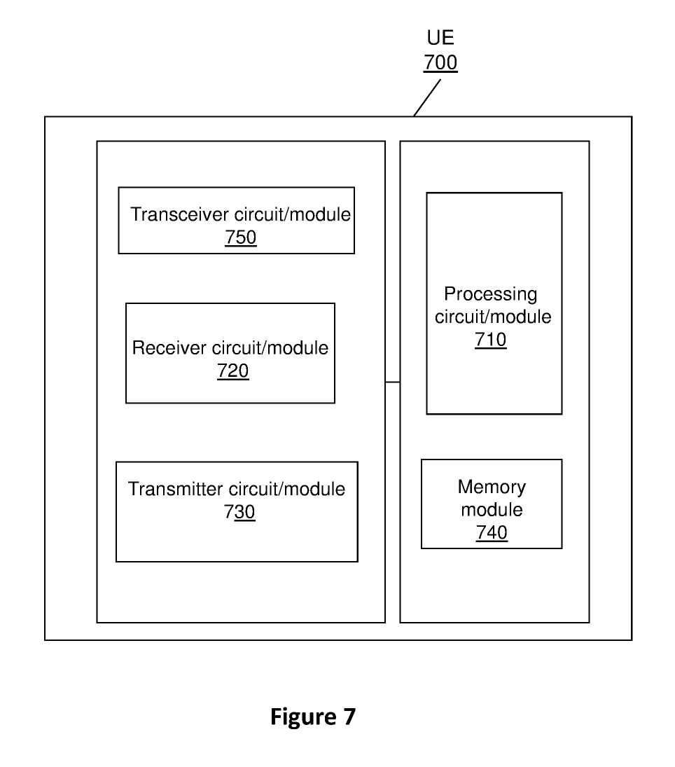

Referring to FIG. 7, there is illustrated a block diagram of a UE 700 applicable configured to operate in an asymmetric carrier aggregation based mobile telecommunications system employing beamforming, according to embodiments herein. The UE 700 comprises a processing circuit or a processing module or a processor or means 710, antenna circuitry (not shown); a receiver circuit or receiver module 720; a transmitter circuit or transmitter circuit 730; a memory module 740 and a transceiver circuit or transceiver module 750 which may include the transmitter circuit 730 and the receiver circuit 720.

The processing module/circuit 710 includes a processor, microprocessor, an application specific integrated circuit (ASIC), field programmable gate array (FPGA), or the like, and may be referred to as the “processor 710.” The processor 710 controls the operation of the UE 700 and its components. Memory (circuit or module) 740 includes a random access memory (RAM), a read only memory (ROM), and/or another type of memory to store data and instructions that may be used by processor 710. In general, it will be understood that the UE 700 in one or more embodiments includes fixed or programmed circuitry that is configured to carry out the operations in any of the embodiments described

In at least one such example, the UE 700 includes a microprocessor, microcontroller, DSP, ASIC, FPGA, or other processing circuitry that is configured to execute computer program instructions from a computer program stored in a non-transitory computer-readable medium that is in, or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the UE operations disclosed herein. Further, it will be appreciated that the UE 700 may comprise additional components not shown in FIG. 7.

The processing circuit 710 is configured to receive from a network node, a cell-specific reference signal (RS) associated with a cell-specific RS process profess. The processing circuit is further configured to receive, from the network node, a configuration configuring the UE with the cell-specific RS which is selected by the network node according to a beam scan pattern comprising the sequence of selected beams; and the processing circuit 710 is further configured; after the configuring, to transmit a beam report to the network node; the beam report comprising one or more of: information on at least one beam direction; and information on the channel between the network node and the UE.

The memory module 740 may contain instructions executable by the processor 710 whereby the UE 700 is operative to perform the previously described method steps. There is also provided a computer program comprising computer readable code means which when run in the UE 700 e.g. by means of the processor 710 causes the UE 700 to perform the above described method steps as disclosed in relation to FIG. 6, which include at least: receiving from a network node, a cell-specific reference signal (RS) associated with a cell-specific RS process profess; receiving, from the network node, a configuration configuring the UE with the cell-specific RS process which is selected by the network node according to a beam scan pattern comprising the sequence of selected beams; and transmitting a beam report to the network node; the beam report comprising one or more of: information on at least one beam direction; and information on the channel between the network node and the UE.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. In particular, it should be noted that although terminology from

1. A method performed by a network node (400) in an asymmetric carrier aggregation based mobile telecommunications system employing beamforming, the method comprising:
selecting (301) a cell-specific reference signal process;
selecting (302) a beam scan pattern on a time-resource grid, wherein the beam scan pattern comprises a sequence of selected beams;
transmitting (303) a cell-specific reference signal, associated to the selected cell-specific reference signal process, according to the selected beam scan pattern comprising the sequence of selected beams;
selecting (304) at least one user equipment, UE, (700) that is subject to the selected beam scan pattern;
configuring (305) the selected at least one UE (700) with the selected cell-specific reference signal process; and
receiving (306) a beam report, from the at least one UE (700), the beam report comprising one or more of: information on at least one beam direction; and information on the channel between the network node and the UE.

2. The method according to claim 1 comprising assigning the cell-specific reference signal process to the UE, for each beam of said UE (700).

3. The method according to claim 1 or claim 2 further comprising adding beam directions with an energy higher than a predefined threshold to ongoing beamformed transmissions.

4. The method according to anyone of claims 1-3 further comprising computing beamforming transmission weights for all UEs in a cell served by the network node and transmitting according to said computed weights.

5. The method according to anyone of claims 1-4 wherein receiving (306) the beam report is done at configured occasions while the network node transmits the cell-specific reference signal at the same configured occasions.

6. The method according to claim 5 further comprising adding a new beam by assigning a new UE specific cell-specific reference signal process.

7. The method according to anyone of claims 1-6 further comprising updating a channel matrix using a channel state information feedback received from the UE configured with the cell-specific reference signal process.

8. The method according to anyone of claim 1-7 further comprising configuring beam scan for additional UEs and/or removing existing configurations of beam scan from UEs currently subject to the beam scan pattern.

9. The method according to anyone of claims 1-8 further comprising increasing or reducing a width of the beam and an associated antenna gain offered by a codebook entry of the antenna defining a direction of the beam.

10. The method according to claim 9 further comprising forming four beams with directions on each side of the direction defined by the codebook entry and scheduling subsequent beamformed transmissions in these directions.

11. The method according to claim 10 further comprising receiving channel state information from each of the four directions and selecting the direction having a channel quality information, CQI, having highest CQI among the received channel state information received from the four directions.

12. A network node (400) in an asymmetric carrier aggregation based mobile communications system employing beamforming, the network node (400) comprising a processor (410) and a memory (440), said memory (440) containing instructions executable by the processor (410) whereby the network node (400) is operative to:
select a cell-specific reference signal process;
select a beam scan pattern on a time-resource grid, wherein the beam scan pattern comprises a sequence of selected beams;
transmit a cell-specific reference signal, associated to the selected cell-specific reference signal process, according to the selected beam scan pattern comprising the sequence of selected beams;
select at least one user equipment, UE, (700) that is subject to the selected beam scan pattern;
configure the selected at least one UE (700) with the selected cell-specific reference signal process; and
receive a beam report, from the at least one UE (700), the beam report comprising one or more of: information on at least one beam direction; and information on the channel between the network node and the UE. (800).

13. The network node (400) according to claim 12 wherein the processor (410) is operative to assign the cell-specific reference signal process to the UE (700), for each beam of said UE (700).

14. The network node (400) according to claim 12 or claim 13 wherein the processor (410) is operative to add beam directions with an energy higher than a predefined threshold to ongoing beamformed transmissions.

15. The network node (400) according to anyone of claims 12-14 wherein the processor (410) is operative to compute beamforming transmission weights for all UEs in a cell served by the network node (400) and transmit according to said computed weights.

16. The network node (400) according to anyone of claims 12-15 wherein the processor (410) is operative to receive the beam report at configured occasions while the network node (400) is operative to transmit the cell-specific reference signal at the same configured occasions.

17. The network node (400) according to claim 16, wherein the processor (410) is operative to add a new beam by assigning a new UE specific cell-specific reference signal process.

18. The network node (400) according to anyone of claims 12-17 wherein the processor (410) is operative to update a channel matrix using a channel state information feedback received from the UE (700) configured with the cell-specific reference signal process.

19. The network node (400) according to anyone of claims 12-18 wherein the processor (410) is operative to configure beam scan for additional UEs and/or removing existing configurations of beam scan from UEs currently subject to the beam scan pattern.

20. The network node (400) according to anyone of claims 12-19 wherein the processor (410) is operative to increase or reduce a width of the beam and an associated antenna gain offered by a codebook entry of the antenna defining a direction of the beam.

21. The network node (400) according to claim 20 wherein the processor (410) is operative to form four beams with directions on each side of the direction defined by the codebook entry and to schedule subsequent beamformed transmissions in these directions.

22. The network node (400) according to claim 21 wherein the processor (410) is operative to receive channel state information from each of the four directions and select the direction having a channel quality information, CQI, having highest CQI among the received channel state information received from the four directions.

23. A method performed by a User Equipment, UE (700) in an asymmetric carrier aggregation based mobile telecommunications system employing beamforming, the method comprising:
receiving (601), from a network node (400), a cell-specific reference signal associated to a cell-specific reference signal process, according to a beam scan pattern comprising the sequence of selected beams, selected by the network node (400);
receiving (602) a configuration from the network node (400), the configuration configuring the UE (700) with the selected cell-specific reference signal process; and
transmitting (603) a beam report, to the network node (400), the beam report comprising one or more of: information on at least one beam direction; and information on the channel between the network node and the UE (700).

24. A User Equipment, UE, (700) in an asymmetric carrier aggregation based mobile communications system employing beamforming, the UE (700) comprising a processor (710) and a memory (740), said memory (740) containing instructions executable by the processor (710) whereby the UE (700) is operative to:
receive, from a network node (400) a cell-specific reference signal associated to a cell-specific reference signal process, according to a beam scan pattern comprising the sequence of selected beams, selected by the network node (400);
receive a configuration from the network node (400), the configuration configuring the UE (700) with the selected cell-specific reference signal process; and
transmit a beam report, to the network node (400), the beam report comprising one or more of: information on at least one beam direction; and information on the channel between the network node and the UE (700).
